(19) United States
(12) Patent Application Publication
(10) Pub. No.: US 2011/0240006 A1
(43) Pub. Date: Oct. 6, 2011

(54) Solar Tracking System and Method

(76) Inventors: Edward J. Linke, Milford, CT (US); David Evarts, Stratford, CT (US); John Pencak, Shelton, CT (US)

(21) Appl. No.: 12/752,557

(22) Filed: Apr. 1, 2010

(51) Int. Cl. F24J 2/38; B23P 15/26

(52) U.S. Cl. 126/600; 29/890.033

(57) ABSTRACT

A solar tracking system for controlled movement of an array of solar panels and a method for installing the system is provided. The system includes an elongate drive shaft rotatable about a central axis and mechanically coupled to an array of solar panels which are rotatable about the drive shaft. A plurality of posts support the drive shaft along the length of the drive shaft, and a plurality of couplers couple the posts to the drive shaft in a manner that facilitates adjustment of the position and orientation of the couplers relative to the posts during installation of the system, and in a manner which minimizes the contact area between the couplers and the drive shaft to reduce the torque and power requirements of the system.

### BACKGROUND OF THE INVENTION

1. Field of the Invention

This invention relates broadly to solar tracking systems for controlled movement of solar panel arrays. More particularly, the invention relates to a terrestrial solar tracking system for controlled movement of solar panel arrays along a single rotational axis.

2. State of the Art

Terrestrial solar tracking systems provide controlled movement of solar panel arrays that convert solar insolation into electrical energy. The amount of electrical energy that a solar panel system is capable of producing is proportional to the total surface area of the panel, as well as the intensity of the insolation that it receives on its surface area. One method of maximizing the amount of sunlight received by a panel is to move the panel in a controlled manner throughout the day such that the surfaces of the panel maintain a perpendicular orientation relative to the direction of travel of the sun's rays as the sun moves across the sky. Controlled movement which maintains the panel in a perpendicular orientation relative to the direction of the sun's rays allows the solar tracking system to collect the highest intensity of solar insolation available throughout the day, and thus to help maximize its electrical output.

The terrestrial solar tracking systems known in the art typically employ multiple drive mechanisms and complex support structure to rotate and align large solar panel arrays, including, for example, tilting the solar panel arrays by moving various structures upon which the solar panels are mounted. As a result, the installation and operation of large solar tracking systems, most of which contain a large number of solar panels, can be complicated and costly, and are often cumbersome to install in the field. In addition, cement ballasts often need to be transported to the site and mounted to such systems to hold them to the ground, which can increase installation and system costs.

### SUMMARY OF THE INVENTION

The present invention is directed to a solar tracking system for supporting an array of solar panels on a mounting surface (e.g., a track of land or roof top) and controlling movement of the array of solar panels, as well as a method of installing the solar tracking system. The solar tracking system includes a drive shaft which is rotatable about a central axis. The drive shaft is mechanically coupled to an array of solar panels such that rotation of the drive shaft about the central axis causes rotation of the solar panels about the central axis. A plurality of posts are provided which extend upward from the mounting surface and support the drive shaft at various locations along the length of the drive shaft via a plurality of couplers. The couplers are adapted to mount to respective top portions of the posts, and to interface to respective portions of the drive shaft to support the drive shaft while allowing rotation thereof. The couplers are also adapted to allow adjustment of their position relative to the posts, which facilitates installation of the solar tracking system and provides flexibility to the system to accommodate various field conditions/obstacles, manufacturing tolerances, and the like.

More particularly, in the preferred embodiment, the drive shaft is an elongate member which includes a plurality of rotatably coupled sections. Each rotatably coupled section includes shaft extensions disposed at opposite ends which interface to a corresponding coupler mounted to a corresponding post. Each shaft extension includes a portion having a circular cross section which interfaces to the coupler to minimize friction therebetween. In this manner, the rotatably coupled sections of the drive shaft are supported by the posts via the couplers as further discussed below. The rotatably coupled sections also preferably include connector plates which mate together to rotationally couple adjacent sections of the drive shaft. The drive shaft thus functions as a single mechanical drive capable of rotating a large array of solar panels with a minimal number of moving parts.

In the preferred embodiment, the plurality of posts provide support to the system and extend vertically upward from the mounting surface in a fixed position and orientation relative thereto. The top portion of each post defines at least one slot which preferably extends in a direction which is either parallel or perpendicular to the longitudinal axis of the post.

In the preferred embodiment, the couplers also preferably define slots configured to be aligned with the slots of the posts to facilitate mounting the couplers to the posts. The slots defined by the couplers and posts also facilitate adjustment of the position of the couplers relative to the posts, which is helpful during system installation. The added flexibility of being able to adjust the position/orientation of a coupler relative to a corresponding post prior to and during installation of the drive shaft facilitates installation of the drive shaft and accommodates system variations in the placement of the posts and/or drive shaft (e.g. caused by misalignment of the posts, differences in manufacturing tolerances of the system parts, field conditions/obstacles such as uneven soil height, etc.). Each coupler preferably includes a pair of offset coupling support members mounted to a corresponding post, which provides increased support and adjustment capability.

According to one aspect of the invention, the slots of the couplers and the posts extend in orthogonal directions relative to each other, which allows the position of a given coupler to be adjusted along first and second orthogonal directions relative to a corresponding post.

According to another aspect of the invention, at least one of the couplers includes a C-shaped bearing surface that interfaces to a corresponding circular cross section of a corresponding shaft extension for support thereof. The C-shaped bearing surface minimizes frictional forces on the drive shaft while providing lateral stability thereto.

In one embodiment, at least one coupler includes both a bracket mounted to a corresponding post and a rotatable member configured to receive a corresponding circular shaft extension. The rotatable member is rotatable relative to the bracket and corresponding post, and thus accommodates variation in the rotational orientation of the posts relative to each other (e.g., rotational slop in the posts and/or drive shaft).

In another embodiment, the drive shaft includes a U-joint operably coupled to adjacent ends of a pair of rotatably coupled sections of the drive shaft. The U-joint allows for articulation of the drive shaft such that at least two rotatably coupled sections of the drive shaft may be positioned in a non-linear configuration.

Installation of the solar tracking system of the present invention includes securing a plurality of the posts at fixed positions and orientations relative to the mounting surface, providing the drive shaft and array of solar panels mechanically coupled thereto, mounting a coupler to each post, and mating a portion of the drive shaft to each coupler. Prior to or during installation of the drive shaft, the position (e.g. the location and/or the rotational orientation of the couplers relative to the posts) may be adjusted to accommodate for variations in field conditions, manufacturing tolerances, and other obstacles frequently encountered during field installations of solar tracking systems.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view of the terrestrial solar tracking system of the invention.

FIG. 2 is an enlarged view of a portion of the terrestrial solar tracking system of FIG. 1.

FIG. 3 is a view of two adjacent rotatably coupled shaft extensions of the drive shaft mounted to a corresponding post by a respective coupler.

FIG. 4 is a view of one embodiment of a coupler which includes a bracket adapted to mount to a corresponding post, and a rotatable member adapted to receive a circular shaft extension.

FIG. 5 is a view of one embodiment of a coupler and a U-Joint mounted to a post to support and rotatably couple two adjacent sections of the drive shaft.

### DETAILED DESCRIPTION OF THE PREFERRED EMBODIMENTS

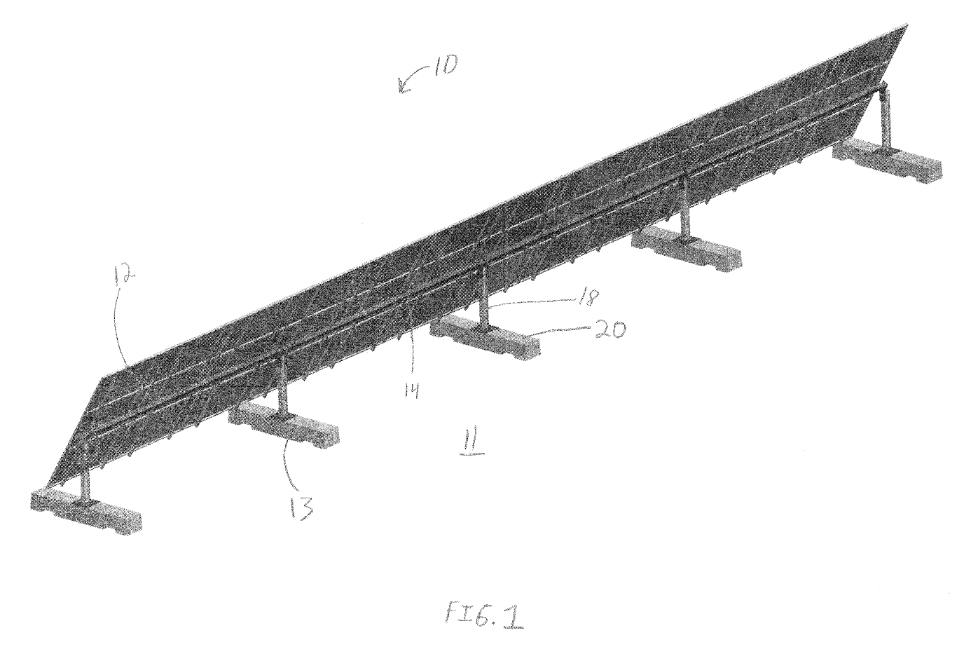

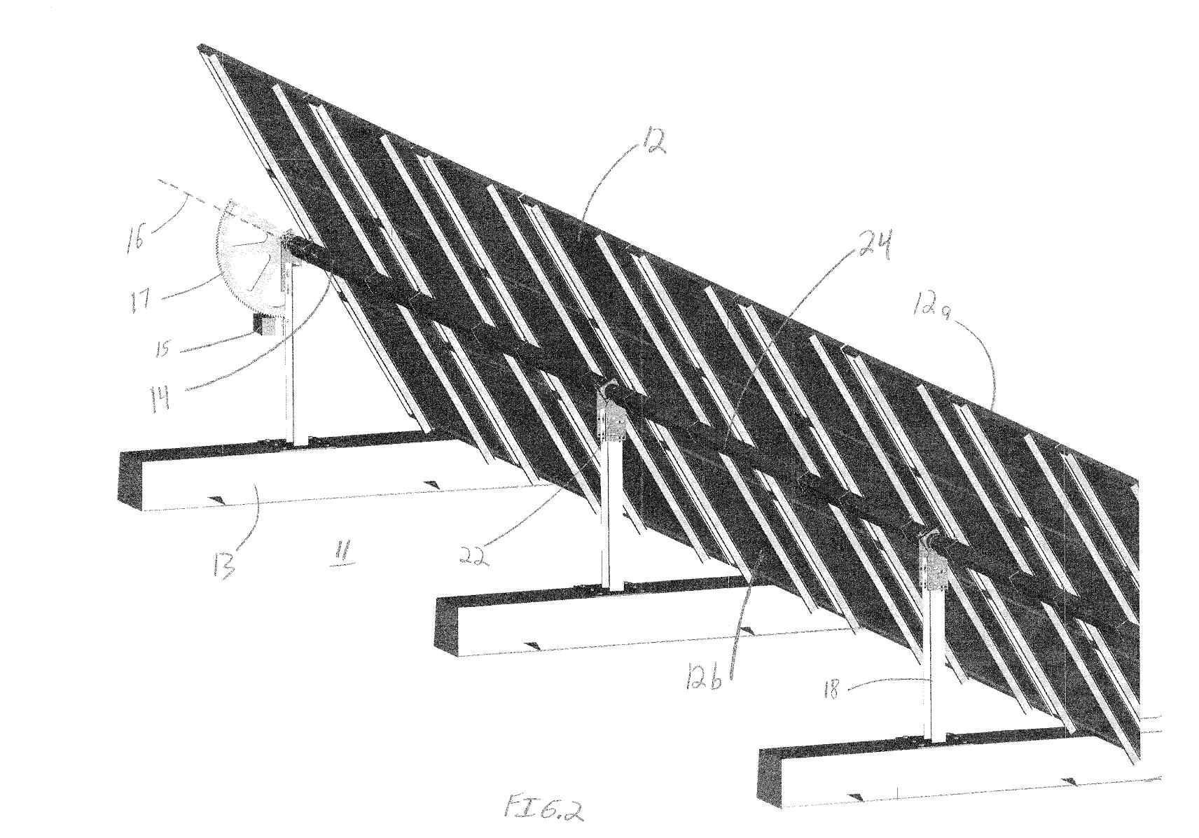

Turning now to FIGS. 1-2, the preferred embodiment of a solar tracking system 10 for supporting an array of solar panels 12 on a mounting surface 11 (e.g., a track of land or rooftop) and controlling movement of the array of solar panels 12 is shown in accordance with the present invention. The solar tracking system 10 includes a drive shaft 14 which is oriented generally parallel with the ground 11 and rotatable about a central axis 16. The drive shaft 14 is rotationally coupled to a motor 15 via an intermediary gear 17, worm gear drive, and/or other suitable motor gear transmission system (not shown), and is mechanically coupled to the array of solar panels 12 such that rotation of the drive shaft 14 about the central axis 16 causes rotation of the solar panels 12 about the central axis 16. Suitable tracker devices and/or photo sensors (not shown) known in the art are preferably provided and electrically coupled to the motor 15 and to a PLC or other controller for controlling rotation of the drive shaft 14 and solar panels 12 to track the sun over the course of a day. Such PLC or controller may be pre-programmed to rotate the drive shaft 14 at set intervals throughout the day, and may also utilize a feedback loop which incorporates data received from the tracker devices and photo sensors to make adjustments to the rotational position of the drive shaft 14 based on actual weather conditions and field conditions (e.g., cloud cover, refraction of sunlight, etc) to maximize the insolation received. A plurality of posts 18 extend upward from a mounting surface 11 to support the drive shaft 14 along the length of the drive shaft 14 via a plurality of couplers 22. The couplers 22 are adapted to mount to respective top portions of the posts 18, and to receive respective portions of the drive shaft 14 to support the drive shaft 14 while allowing rotation thereof. The couplers 22 are also adapted to allow adjustment of the position of the couplers 22 relative to the posts 18, which facilitates installation of the solar tracking system 10 and accommodates various field conditions and manufacturing tolerances. The components of the solar tracking system 10 are described in more detail below, followed by a brief description of their installation.

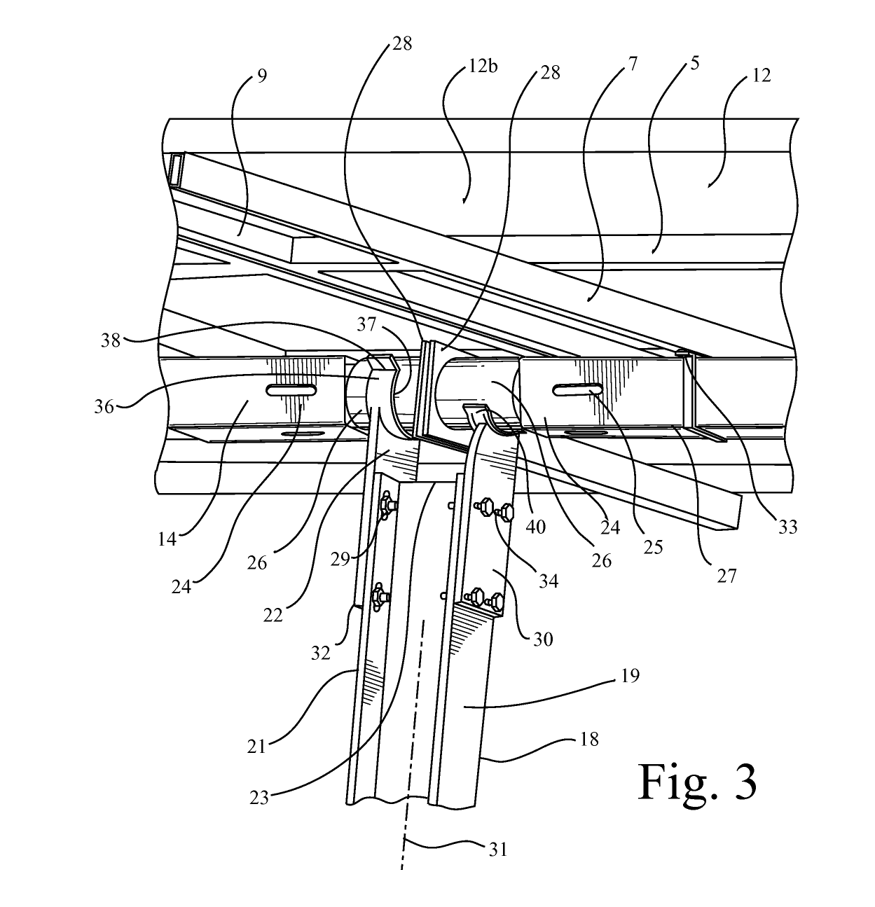

As shown most clearly in FIGS. 2-3, in the preferred embodiment, the drive shaft 14 of the solar tracking system 10 is an elongate hollow member which includes a plurality of rotatably coupled sections 24. The drive shaft 14 may have a generally rectangular cross section as shown, but may also be shaped in the form of other structural beams or tubing, and should be generally symmetrical with respect to the central axis 16 about which it rotates. The drive shaft 14 must be strong enough to support the torsional, bending, tensile, and/or compressive forces/stresses inherent in the system 10 on account of, for example, the weight of the panels 12, the torque transmitted from the motor 15, and wind forces in any desired tracking position. As shown in FIG. 2, each rotatably coupled section 24 of the drive shaft 14 extends between and is supported by two posts 18. The posts 18 may be I-beams as shown or other types of posts, such as C-channel posts, circular posts, etc.

As shown in FIG. 3, the rotatably coupled sections 24 of the drive shaft 14 preferably define horizontally directed slots 25 through the outer wall 27 of the rotatably coupled sections 24. The rotatably coupled sections 24 also preferably include shaft extensions 26 mounted to opposite ends of the rotatably coupled sections 24. The slots 25 allow for attachment of the shaft extensions 26 to the rotatably coupled sections 24 by welding or other fastening means. Each shaft extension 26 may be mounted to the inside of the respective drive shaft section 24 as shown (via welding, threads, or any other fastening means known in the art suitable for sustaining over long term use the types of loads provided to the drive shaft 14 in large terrestrial solar systems), or may alternatively be mounted to the outside of the drive shaft 14. The shaft extensions 26 include portions which have a circular cross section, which enables them to be received by the respective couplers 22 (further discussed below), and thus to be supported by the corresponding posts 18 without significantly restricting their rotational capability.

The rotatably coupled sections 24 of the drive shaft 14 also preferably include connector plates 28 mounted to the shaft extensions 26. The connector plates 28 are preferably metal flanges which are welded to the outer surface of the shaft extensions 26 and extend orthogonally outward therefrom (e.g., orthogonal to the longitudinal direction of the shaft extension 26). The connector plates 28 each define a centered hole which is large enough to accommodate the outer diameter of a corresponding shaft extension 26. Alternatively, each connector plates 28 may simply be mounted to the end of a corresponding shaft extension 26. While the connector plates 28 are shown as square shaped, connector plates having other shapes can be utilized. It will be appreciated that the connector plates 28 must be mounted to the shaft extensions 26 firmly enough to avoid slippage as torque is transmitted between the rotationally coupled sections 24 of the drive shaft 14. Therefore, welding is the preferred means of attachment, but other suitable fastening means may also be employed. As shown in FIG. 3, adjacent connector plates 28 mounted to adjacent shaft extensions 26 are matable to rotationally couple the adjacent shaft extensions 26, and hence adjacent sections 24 of the drive shaft 14. Nuts, bolts, or other fasteners (not shown) may be used to secure the connector plates 28 together. It will be appreciated that the connector plates 28 must be dimensioned small enough to be able to freely rotate without contacting either the top of the support post 18 or any of the supports 9 used to mechanically couple the array of solar panels 12.

As shown in FIG. 2, the rotatably coupled sections 24 of the drive shaft 14 function as a single mechanical drive capable of rotating a large array of solar panels 12 with a minimal number of moving parts, and capable of being driven by a single motor 15. The motor 15 is rotatably coupled to the drive shaft 14 via the intermediary gear 17 operably disposed at one end of the drive shaft 14 and preferably centered about the central axis 16. Rotational coupling between the motor 15 and the intermediary gear 17 may be accomplished by a worm-drive gear assembly (not shown) or other standard gear assembly commonly employed in the art. 5. Means for controlling the motor 15 to selectively rotate the drive shaft 14 to align the solar panels 12 with a given sun location may also be provided by an suitable means known in the art.

Turning now to the support structure of the system 10, the plurality of posts 18 preferably extend vertically upward relative to the ground 11 and are preferably arranged in a linear manner offset from each other along the length of the drive shaft 14. As shown in FIGS. 1-2, transversely directed ballasts 13 may be provided for added stability, and the posts 18 may be bolted or welded to the ballasts 13 so that they extend upward from the top surface 20 thereof. The ballasts 13 may be made from concrete or other sturdy material. Alternatively, the posts 18 may be driven into the ground 11 without utilizing any ballasts 13. Concrete or other suitable material may also be used to further support the posts 18 driven into the ground 11 and provide lateral stability thereto. It will be appreciated that the ability to utilize single support posts 18 at multiple locations along the length of the drive shaft 14 (as opposed to multiple posts at each location, tri-pod arrangements, etc.) will reduce the system's installation time, cost, and complexity.

As best shown in FIG. 3, each post 18 is preferably an I-beam having oppositely facing flanges 19, 21, though other structures and shapes may be utilized. The top portion 23 of each post 18 defines at least one slot 29 which preferably extends in a direction which is either parallel or perpendicular to the longitudinal axis 31 of the post 18.

Each coupler 22 preferably includes a pair of coupling support members 30, 32 offset from one another and mounted to, respectively, the oppositely facing flanges 19, 21 of the post 18 for added support and adjustment capability. The coupling support members 30, 32 of the coupler 22 also define slots 34 which preferably extend in a direction which is either parallel or perpendicular to the longitudinal axis 31 of the post 18, but preferably in a direction opposite the direction of the slots 29 of the top portion 23 of the respective post 18. Alternatively, the slots 29, 34 of the post 18 and coupler 22 may extend in other directions, but preferably in transverse directions relative to each other when the post 18 and coupler 22 are aligned with each other.

The slots 29, 34 defined by the couplers 22 and posts 18 facilitate mounting the couplers 22 to the posts 18 and adjusting the position of the couplers 22 relative to the posts 18, thus providing the solar tracking system 10 with the capacity to accommodate variations in the positioning and rotational orientation of the posts 18 relative to each other, and to accommodate variations in positioning of the rotatably coupled sections 24 of the drive shaft 14 (e.g. caused by differences in manufacturing dimensions of the parts of the system 10, by field conditions such as uneven soil height, by installation difficulties, etc.).

With further reference to FIG. 3, each of the coupling support members 30, 32 preferably includes a C-shaped portion 36 disposed at the top thereof. The C-shaped portion 36 has a bearing surface 37 for supporting a corresponding shaft extension 26 and for transferring radial forces applied thereto down to the post 18 via the coupling support member 30 while minimizing frictional forces on the shaft extension 26 and providing lateral stability thereto. The C-shaped bearing surface 37 may comprise a Teflon®material, a material having a high density molecular weight such as Polyethylene, or other non-stick materials known in the art. Other bearing configurations can also be used. Each C-shaped portion 36 has a first end 38 which is preferably disposed on one side of the drive shaft 14 above a plane (not shown) which is parallel with the ground 11 and extends through the center axis 16 of the drive shaft 14, and a second end 40 on an opposite side of the drive shaft 14 which is preferably disposed below the plane (e.g., the C-shaped portion 36 partially surrounds the drive shaft 14 but is not symmetrical with respect to the bottom of the shaft extension 26 to which it interfaces). As shown in FIG. 3, the respective C-shaped portions 36 of the oppositely facing coupling support members 30, 32 are oppositely oriented about their respective shaft extensions 26. This provides lateral support to both of the shaft extensions 36 of the drive shaft 14 at each post 18 while minimizing the total amount of bearing surface area 37 in contact with the drive shaft 14 at each post 18.

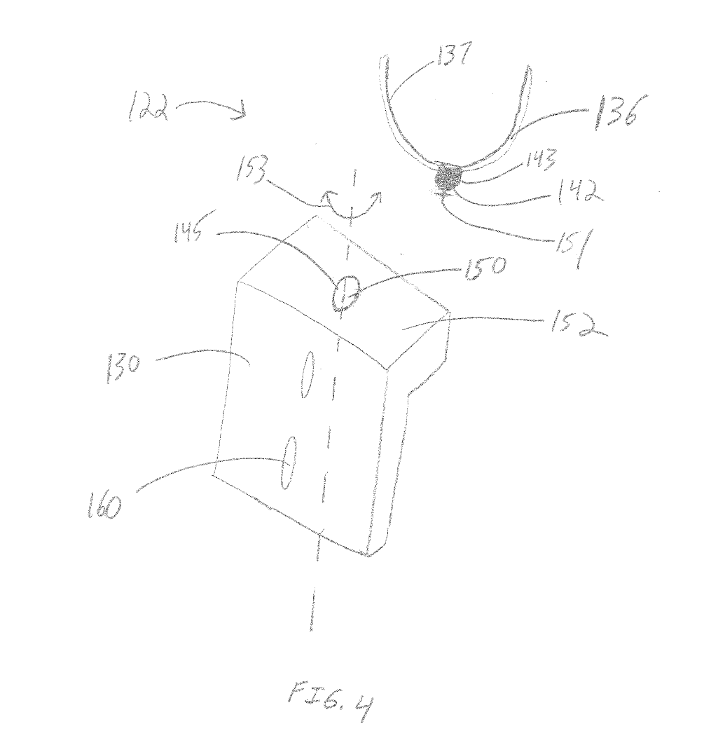

Turning to FIG. 4, an alternative embodiment of a coupler 122 is shown which includes a single coupling support member (e.g. a bracket) 130 for attaching to a post 18, and a rotatable, detachable, C-shaped member 136 for supporting a corresponding shaft extension 26 and transferring radial forces applied thereto down to the post 18 via the coupling support member 130 while minimizing frictional forces on the shaft extension 26 and providing lateral stability thereto. The C-shaped member 136 includes a C-shaped bearing surface 137 which may comprise a Teflon® material or other suitable wear-resistant lubricant material known in the art, as well as a conically shaped mounting fastener 142 which is insertable into a hole 150 defined by an upper flange 152 of the coupling support member 130. The mounting fastener 142 is provided with curved edges 143 to reduce friction with the edges 145 of the hole 150. A locking pin 151 or other fastener is provided to lock the C-shaped member 136 to the bracket 130 in a desired rotational orientation.

It will be appreciated that the rotatable member 136 is rotatable relative to the coupling support member 130 in the direction of the arrows 153. The C-shaped bearing surface 137 is adapted to receive the circular cross section of a corresponding shaft extension 26 of the drive shaft 14. The coupler 122 may be fastened to a corresponding post 18 via holes 160 defined by the coupling support member 130, and the rotatable member 136 rotated to accommodate rotational slop in the post 18 or drive shaft 14 during installation. In this manner, the system 10 is provided with the capability of accommodating variation in the rotational orientation of the posts 18 relative to each other. For example, if the posts 18 are I-beams as discussed above, then if the I-beams are installed with different rotational orientations, then the couplers 122 mounted thereto will also have a different rotational orientation on account of the location of the slots 160. The rotatable member 136 allows the coupler 122 to receive a shaft extension 26 of the drive shaft 14 at a given post 18, notwithstanding the rotational orientation of the corresponding post 18 and coupling support member 130 mounted thereto.

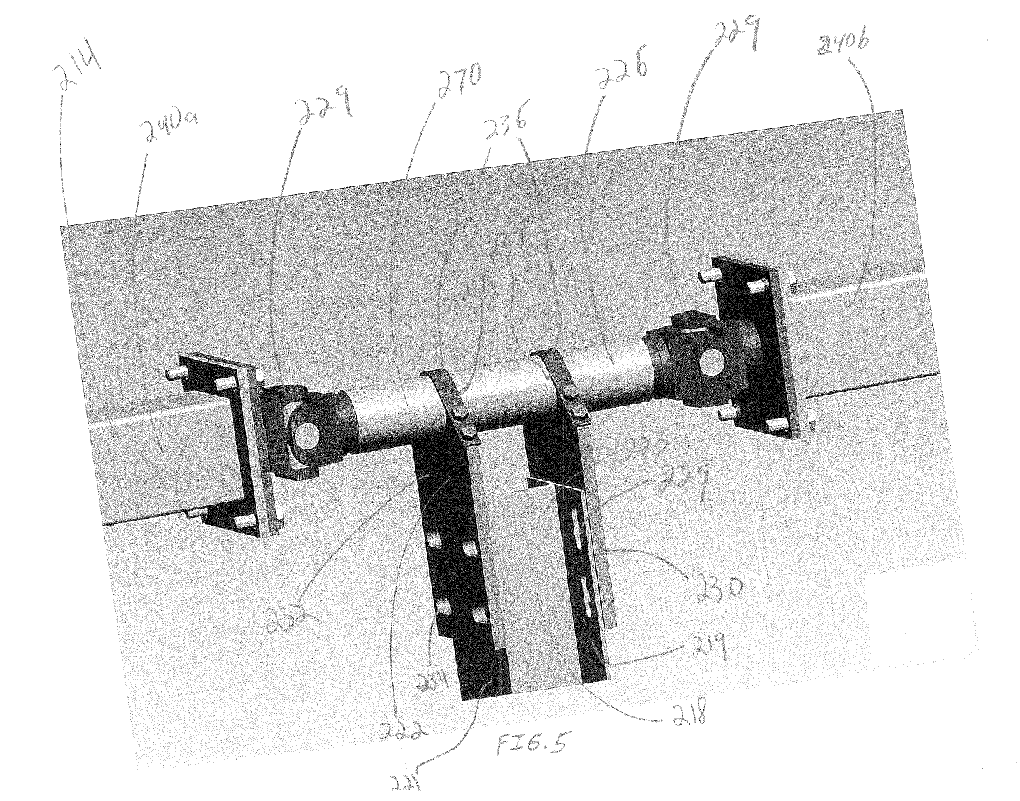

Turning to FIG. 5, in another embodiment of the invention, two adjacent rotatably coupled sections 240a, 240b are rotatably coupled to each other by a U-joint 270. The U-joint 270 includes a shaft extension 226 and end members 229 which allow articulation of the drive shaft 214 between the rotatably coupled sections 240a, 240b such that the rotatably coupled sections 240a, 240b may be positioned in a non-linear configuration. Any type of U-joint known in the art may be used which is suitable for rotatably coupling sections of a drive shaft in terrestrial solar array applications. A coupler 222 is provided which includes a pair of coupling support members 230, 232 offset from one another and mounted to, respectively, the oppositely facing flanges 219, 221 of the post 218 for added support and adjustment capability. The coupling support members 230, 232 of the coupler 222 also define slots 234 which preferably extend in a direction which is either parallel or perpendicular to the longitudinal axis of the post 218, but preferably in a direction opposite the direction of the slots 229 of the top portion 223 of the respective post 218.

Each of the coupling support members 230, 232 preferably each include an interface portion 236 disposed at the top thereof for interfacing to the shaft extension 226. The interface portion 236 has a bearing surface 237 (hidden) for supporting the shaft extension 226 and for transferring radial forces applied thereto down to the post 218 via the coupling support member 230 while minimizing frictional forces on the shaft extension 226 and providing lateral stability thereto. The bearing surface 237 may comprise a Teflon® material or other suitable wear-resistant lubricant material known in the art. Other bearing configurations can be used.

While the specific structure 9 which couples the solar panels 12 to the drive shaft 14 has not been discussed herein, it will be recognized by those skilled in the art that any number of different support structures may be used to mount the solar panels 12 to the sections 24 of the drive shaft 14, such as, for example, as disclosed in U.S. Pat. No. 4,429,178 to Prideaux (Prideaux) and U.S. Patent Pub. No. 2008/0308091 to Corio (Corio), which are herein incorporated by reference in their entirety. By way of example, the panels 12 may be maintained in an end-to-end relationship with one another within a common plane as shown in FIG. 1 and as disclosed in Prideaux. Alternatively, horizontal spacing may be provided between adjacent panels. Each panel may be, for example, comprised of 4′×4′ module panels interconnected as a single unit to define a continuous flat solar collecting front side 12a. Larger or smaller modular panels may also be used. Transversely directed brace members 7 (e.g., brace members which extend in a transverse direction relative to the central axis 16 of the drive shaft 14) may attach to parallel brace members 5 (e.g., brace members which extend in a direction generally parallel to the central axis 16) which are mounted to the rear side 12b of the panels 12. The transversely directed brace members 7 may be mounted to the rotatably coupled sections 24 of the drive shaft 14 via brackets 33 attached to the drive shaft 14, thus allowing simultaneous rotation of the panels 12 about the drive shaft 14 in tracking relationship with the sun.

Regarding assembly and installation of the solar tracking system 10, it will be appreciated that the drive shaft 14 may be stored in sections 24 at a warehouse or factory. For example, the sections 24 of the drive shaft 14 may be stored with the brace members 5, 7 and respective panels 12 attached thereto and with the sections 24 stacked on top of each other to conserve space and to allow the sections 24 to be easily loaded onto a flatbed truck, cargo/freight train, or the like and delivered to a remote installation location. At the installation location, the posts 18 may be driven into the ground 11 in a preferably vertical orientation relative to the ground 11. Alternatively or additionally, the posts 18 may be attached to the cement ballasts 13. It will be appreciated that using cement ballasts 13 to mount the posts 18 without driving the posts 18 into the ground 11 allows the posts 18 to be moved as needed prior to and during installation of the system 10, but increases the material and shipping costs of the system 10 and generally requires larger heavier ballasts 13. A plurality of the posts 18 are secured at fixed positions and orientations relative to the mounting surface 11 depending upon the requirements of and the site conditions at a given installation.

A coupler 22 is loosely mounted to each post 18 as discussed above. Each section 24 of the drive shaft 14, preferably with the brace members 5, 7 and respective panels 12 already attached thereto as discussed above, is then loosely mounted to the C-shaped portions 36 of a respective coupler 22 at each post 18 via the slots 29, 34 defined by the posts 18 and the coupling support members 30 of the couplers 22. The couplers 22 may be adjusted in position and orientation as described above to accommodate for positional and rotational slop in the posts 18 and drive shaft sections 24. U-joints 270 and/or other alternative couplers may be provided as needed. The couplers 22 are then firmly tightened to the posts 18 and sections 24 of the drive shaft 14.

There have been described and illustrated herein several embodiments of a terrestrial solar tracking system and a method of installing the same. While particular embodiments of the invention have been described, it is not intended that the invention be limited thereto, as it is intended that the invention be as broad in scope as the art will allow and that the specification be read likewise. Thus, while particular shapes, sizes, and types of drive shafts, posts, mating plates, and couplers have been disclosed, it will be appreciated that other shapes, sizes, and types of drive shafts, posts, mating plates, and couplers maybe used as well. In addition, while particular types of slots and nuts or bolts have been disclosed for mounting couplers to support posts, it will be understood that other types of fasteners and fastening methods may be employed. Also, while a single drive shaft comprised of multiple rotatably coupled sections is preferred, it will be recognized that multiple drive shafts driven by multiple motors may be used. Furthermore, while C-shaped bearing surfaces and specific types of bearing surfaces have been disclosed for interfacing to portions of the drive shaft, it will be understood that bearing surfaces of different types and shapes may be utilized. Moreover, while a particular method for installation of a drive shaft and associated support structure has been disclosed, it will be appreciated that other method steps may be utilized, that the method steps may be done in a different order, and that some method steps may be omitted. It will therefore be appreciated by those skilled in the art that yet other modifications could be made to the provided invention without deviating from its spirit and scope as claimed.

What is claimed is:

1. A solar tracking system for controlled movement of an array of solar panels, the system comprising:
an elongate drive shaft having a central axis and extending along a length, said drive shaft rotatable about the central axis and mechanically coupled to the array of solar panels such that rotation of said drive shaft about said central axis causes rotation of said array of solar panels about said central axis;
a plurality of posts extending upward from a mounting surface along respective longitudinal axes that are substantially vertical in orientation, said plurality of posts offset from one another along the length of said drive shaft for supporting said drive shaft, the longitudinal axis of each post having a fixed position and orientation relative to said mounting surface; and
a plurality of couplers corresponding to said plurality of posts, a given coupler mechanically coupling a top portion of a corresponding post to the drive shaft while allowing rotation of the drive shaft, the given coupler configured to allow adjustment of position of the given coupler relative to the corresponding post along first and second orthogonal directions.

2. (canceled)

3. A solar tracking system according to claim 1, wherein:
the first direction is along the longitudinal axis of the corresponding post and the second direction is transverse to the longitudinal direction of the corresponding post.

4. A solar tracking system according to claim 1, wherein:
the given coupler further allows for adjustment of rotational orientation of the given coupler about the longitudinal axis of the corresponding post.

5. A solar tracking system according to claim 1, wherein:
the given coupler includes a pair of coupling support members mounted to the corresponding post and offset from one another.

6. A solar tracking system according to claim 5, wherein:
said pair of coupling support members comprise mounting plates each defining a plurality of slots that are aligned with corresponding slots in the corresponding post for facilitating mounting of said mounting plates to said corresponding post and adjustment of position of said coupling support members relative to said corresponding post.

7. A solar tracking system according to claim 1, wherein:
said given coupler includes a bearing surface for supporting a portion of said drive shaft.

8. A solar tracking system according to claim 7, wherein:
said bearing surface partially encircles the portion of said drive shaft with an opening sized to receive the portion of said drive shaft.

9. A solar tracking system according to claim 8, wherein:
said bearing surface is C-shaped.

10. A solar tracking system according to claim 7, wherein:
said bearing surface includes a first lower end disposed on one side of said drive shaft, and a second upper end disposed on an opposite side of said drive shaft, said first lower end disposed vertically lower than said second upper end relative to said mounting surface, said first lower end and said second upper end defining the opening for receiving said drive shaft.

11. A solar tracking system according to claim 1, wherein:
said given coupler includes a bracket and a support member, said bracket mounted to said corresponding post, said support member configured to receive a portion of said drive shaft, wherein said support member is mounted to said bracket in a manner that allows for rotation of said support member relative said bracket and the corresponding post.

12. A solar tracking system according to claim 11, wherein:
said support member includes a bearing surface that partially encircles a portion of said drive shaft with an opening sized to receive the portion of said drive shaft.

13. A solar tracking system according to claim 12, wherein:
said bearing surface is C-shaped.

14. A solar tracking system according to claim 1, wherein:
said drive shaft includes a plurality of rotatably coupled sections.

15. A solar tracking system according to claim 14, wherein:
at least two rotatably coupled sections of said drive shaft are positioned in a non-linear configuration.

16. A solar tracking system according to claim 14, wherein:
said drive shaft includes a plurality of shaft extensions disposed at opposite ends of said rotatably coupled sections, and said plurality of couplers interface to said shaft extensions to support said drive shaft.

17. A solar tracking system according to claim 16, wherein:
said shaft extensions have a circular cross section.

18. A solar tracking system according to claim 16, wherein:
said drive shaft includes a plurality of connector plates mounted to said shaft extensions, said connector plates matable to rotationally couple said rotatably coupled sections of said drive shaft.

19. A solar tracking system according to claim 18, wherein:
said connector plates are rectangular.

20. A solar tracking system according to claim 14, wherein:
said rotatably coupled sections have a non-circular cross-section.

21. A solar tracking system according to claim 14, wherein:
said drive shaft includes a U-joint operably coupled to adjacent ends of a pair of rotatably coupled sections of said drive shaft for allowing articulation thereof.

22. A solar tracking system according to claim 1, wherein:
said posts are disposed in a linear configuration.

23. A solar tracking system according to claim 1, wherein:
said posts are I-beams or other post configurations.

24. A solar tracking system according to claim 1, further comprising:
a motor operably coupled to said drive shaft for rotating said drive shaft.

25. A solar tracking system according to claim 1, further comprising:
means for controlling said motor to selectively rotate said drive shaft.

26. A solar tracking system according to claim 25, further comprising:
means for aligning the solar panels with a given sun location.

27. A method for installing a solar tracking system for controlled movement of an array of solar panels, comprising:
securing a plurality of posts at fixed positions and orientations relative to a mounting surface, the posts extending upward from the mounting surface along respective longitudinal axes that are substantially vertical in orientation;
providing an elongate drive shaft having a central axis, said drive shaft rotatable about the central axis and mechanically coupled to the array of solar panels during use such that rotation of said drive shaft about said central axis causes rotation of said array of solar panels about said central axis;
for each given post of said plurality of posts, mounting a respective coupler to the given post and mating a portion of the drive shaft to the respective coupler, wherein the respective coupler mechanically couples a top portion of the given post to the drive shaft while allowing rotation of the drive shaft, and the respective coupler is configured to allow adjustment of position of the respective coupler relative to the corresponding post along first and second orthogonal directions.

28. A method according to claim 27, wherein:
said drive shaft includes a plurality of rotatably coupled sections with an extension between adjacent sections to realize an end-to-end configuration, said extension mating to a respective coupler.

29. (canceled)

30. A method according to claim 27, wherein:
the first direction is along the longitudinal axis of the corresponding post and the second direction is transverse to the longitudinal direction of the corresponding post.

31. A method according to claim 1, wherein:
the respective coupler further allows for adjustment of rotational orientation of the respective coupler about the longitudinal axis of the corresponding post.
